(19) United States
(12) Patent Application Publication
(10) Pub. No.: US 2015/0133034 A1
(43) Pub. Date: May 14, 2015

(54) MACHINE TOOL COMPRISING A SPINDLE HEAD AND METHOD FOR POSITIONING A SPINDLE HEAD OF A MACHINE TOOL

(71) Applicant: FRITZ STUDER AG, Steffisburg (CH)

(72) Inventors: Michael LUTHI, Aeschi b. Spiez (CH); Mark SCHNYDER, Glis (CH)

(21) Appl. No.: 14/598,946

(22) Filed: Jan. 16, 2015

Related U.S. Application Data
(63) Continuation of application No. PCT/EP2013/065234, filed on Jul. 18, 2013.

(30) Foreign Application Priority Data
Jul. 20, 2012 (DE) 102012106616.7

(51) Int. Cl. B24B 41/00; B23Q 1/00; B23Q 5/34; B24B 49/00

(52) U.S. Cl. CPC B24B 41/005; B24B 49/00; B23Q 1/0045; B23Q 5/34
USPC 451/11; 451/178; 451/28

(57) ABSTRACT

The present disclosure relates to a machine tool for machining workpieces, particularly a grinding machine, and to a method for positioning a spindle head of such a machine tool. The machine tool comprises a workpiece holder for receiving a workpiece, and a spindle head for receiving a tool, particularly a grinding wheel, wherein the spindle head is movable by motor with respect to the workpiece holder, wherein a handle is arranged at the spindle head and comprises at least one detector that is arranged to detect an impact on the handle, and wherein a control device is provided that is arranged to move the spindle head in at least one operation mode by motor in a defined manner dependent on the detected impact on the handle.

### CROSS-REFERENCES TO RELATED APPLICATIONS

This application is a continuation of International Patent Application PCT/EP2013/065234, filed on Jul. 18, 2013 designating the U.S., which International Patent Application has been published in German language and claims priority from German patent application 10 2012 106 616.7, filed on Jul. 20, 2012. The entire content of these priority applications are fully incorporated by reference herewith.

### BACKGROUND

The disclosure relates to a machine tool for machining workpieces, particularly a grinding machine, comprising a workpiece holder for receiving a workpiece, and a spindle head for receiving a tool, particularly a grinding wheel. The disclosure further relates to a method for positioning a spindle head of a machine tool for machining workpieces, particularly a grinding machine.

Machine tools, particularly grinding machines, are known in the art. By way of example, grinding machines may comprise tools that are shaped in a rotationally symmetric fashion, particularly grinding wheels. These may cooperate in an adequate manner with a workpiece for removing material. By way of example, cylindrical grinding machines may be arranged for external cylindrical grinding, internal cylindrical grinding, or for infeed grinding and angular infeed grinding, respectively. Besides grinding wheels generally also abrasive belts may be utilized for cylindrical grinding. Besides rotationally symmetric surfaces, also eccentrically shaped workpiece surfaces may be machined when the workpiece holder and the tool unit are appropriately drivable and movable with respect to each other. In this way, for instance, camshafts, crankshafts or similar workpieces comprising eccentric geometries may be machined and/or grinded. Further, machine tools are known that enable combined machining of workpieces, such as combined grinding and turning machines.

A to-be-machined workpiece may be received between two centers of a workpiece holder, for instance, or may be one-sidedly received at a workpiece holder. Besides, so-called centerless grinding is known which involves that the workpiece is not (axially) received between centers of the grinding machine, but rather received and guided via receiving bars, regulating wheels, guiding rollers and the like, for instance.

Machine tools, particularly grinding machines, may comprise different operation modes. By way of example, in an automated (operative) operation mode, a previously programmed machining task may be executed in an essentially fully automated fashion. Regularly, such operation modes do not require a manual intervention of a user. Due to previously stored machining paths, the machine tool by itself may execute infeed movements, feed movements and further positioning of the tool.

However, also operation modes are known that require an at least partial manual control of components of the machine tool, particularly of the spindle head including the received tool. To these belong particularly equipping procedures and set-up procedures. It may be further envisaged to have the spindle head of the machine tool operated by a user (or fitter) when executing manual measurement operations. By way of example, setting-up may be required when the tool (e.g., the grinding wheel) is replaced or at least dressed. It may be required in this context to approach defined reference points of the machine tool that are, for instance, pre-defined at the machine table or the machine bed. To this end, it is often possible to lead the spindle head by means of a rough movement (fast gear) to the vicinity of a reference point and, thereafter, to touch the reference point by means of a fine movement (crawler gear) to accomplish the approaching procedure.

Machine tools are known whereby the operator (or fitter) may control the spindle head via an external operator interface that comprises an input unit. The input unit may be embodied by buttons, number pads, touchscreens or similar arrangements. Further, the operator interface may comprise an output unit, usually a display for displaying absolute and relative positions and displacement paths. In this way, the operator may operate the spindle head in a “mediate” fashion to move the spindle head as desired. Frequently, the operator interface is coupled to the machine tool, however, determined by the system, often arranged in such a manner that the operator often may not apply attention simultaneously to both the input and output unit and to the (real) spindle head. Instead, it is frequently required to alternately observe the operator interface and the spindle head, when manually controlling the spindle head, to execute the desired displacement paths at sufficient accuracy and speed without collisions.

In view of this, it is an object to provide a machine tool, particularly a grinding machine, and a positioning method that enable manually controlling traveling and positioning of the spindle head with little effort.

It is a further object to provide a respective machine tool, wherein traveling and positioning of the spindle head can be performed in a quick fashion.

It is yet a further object to provide a respective machine tool, wherein traveling and positioning of the spindle head, wherein the risk of maloperation can be reduced.

It is still a further object to provide a corresponding method for positioning a spindle head of a machine tool.

### SUMMARY

In accordance with one aspect of the present disclosure, these and other objects are achieved by a machine tool for machining workpieces, particularly a grinding machine, comprising a workpiece holder for receiving a workpiece, a spindle head for receiving a tool, particularly a grinding wheel, wherein the spindle head is movable by motor with respect to the workpiece, wherein a handle is arranged at the spindle head and comprises at least one detector that is arranged to detect an impact on the handle, and wherein a control device is provided that is arranged to move the spindle head in at least one operation mode by motor in a defined manner under consideration of detected impacts on the handle.

In accordance with the above aspect, an operator may namely induce a displacement of the spindle head by motor by directly impacting on the spindle head via the handle. A sensation of immediately, directly moving the spindle head may become apparent to the operator. The movement (also: positioning) may be performed by intuition. It goes without saying that the movement of the spindle head does not take place directly but rather via a “detour”, namely by means of motorized positioning procedures that are prompted by the control device.

However, the operator (or fitter) may have the impression that the spindle head is movable solely by human force. The movement of the spindle head may further provide direct feedback to the operator. For instance, the operator may cause an increased travel speed by increasing the force which he exerts to the handle. A reduction of the force applied by the operator may prompt a reduced travel speed, up to an idle state of the spindle head. A particularly intuitive and simple positioning of the spindle head may be achieved in this way. This may take place in a clearly quicker fashion compared to conventional solutions, since the operator does not have to constantly address his attention in an alternating manner to the spindle head and to user interfaces that are arranged remotely therefrom. In conventional machine tools, this is appropriate to ensure oneself that operator inputs are transferred into desired spindle head movements.

It goes without saying that the handle is deliberately not arranged in a manner fixed to the frame of the machine tool or, for instance, in a hand held manner (e.g. as a “remote control”). Rather, the handle may be fixedly attached to the spindle head, particularly directly to the spindle head, and movable with the spindle head.

The machine tool may be arranged as a cylindrical grinding machine, for instance as a universal cylindrical grinding machine. The spindle head may be particularly arranged as a grinding head comprising a grinding spindle. The workpiece holder may for instance comprise a workpiece spindle which may be supplemented by a tailstock. The workpiece holder may further comprise clamping devices (e.g. chucks) or receiving centers for the workpiece. Generally, the workpiece holder however may be further arranged for centerless grinding.

It goes without saying that the relative movement of the spindle head with respect to the workpiece holder may be achieved for instance by the workpiece holder being fixed and the spindle head being moved. It may be however further envisaged to fix the spindle head and to move the workpiece holder. Further, a combined relative movement may be envisaged which comprises moving both the spindle head and the workpiece holder relative to each other.

The handle may be embodied by a grip or a joystick. The handle may be particularly arranged as T-grip, bow grip, grip plate, cylindrical grip, spherical grip, ball grip, conical grip, mushroom-shaped grip, or in a similar fashion. Further, the handle may be coupled via a grip rod (or shaft) with the spindle head.

The detector may be arranged as a measurement detector and comprise an actuation sensor or actuation detector.

The impact on the handle is generally performed by the operator. The impact may involve a deformation, a deflection, an elongation of the handle or the like. The detected impact may be representative of a particular actuation of the handle, for instance of height or direction of an actuation force that is exerted to the handle.

Depending on the detected impacts, the spindle head may be displaced by motor. The dependency may be defined by means of a characteristic map which may interrelate motion parameters and type and extent of detected impacts. Generally, “dependent” may be understood as, for instance, “proportional to”, “not proportional but having the same direction” and the like, which represent a general relationship. This dependency may for instance pertain to motion parameters of the displacement motion such as direction, path, speed, acceleration, or the like.

According to one embodiment, the detector is arranged to detect an actuating force that is applied to the handle.

The actuating force the operator is applying to the handle may be detected by the detector in a mediate or immediate fashion. A mediate detection may be based on the detection of deformations, for instance, that may be caused by (material) tensions that are caused by the actuating force. Hence, well-known principles of force measurement may be utilized. It goes without saying that not necessarily a highly accurate absolute determination of the actuating force is required. Rather, the point may be for instance to detect “at which strength” and “in which direction” the operator acts on the handle.

According to another embodiment, the machine tool further comprises a displacement drive comprising at least one controlled axis for the spindle head, wherein the control device routes control commands to the displacement drive that are generated dependent on the detected impacts on the handle.

The displacement drive may comprise at least one drive, generally a plurality of drives (e.g. motors). Each of the drives may be assigned to an axis, respectively. For instance, the drives may be assigned to the spindle head, the machine bed, or to a slide that is interposed therebetween. For instance, the slide may be arranged as a cross slide that provides two movable axes. Generally, it may be envisaged to move the spindle head along the at least one controlled axis (e.g. X-axis or Z-axis) in a linear fashion. However, it may be also envisaged to provide a drive that enables to swivel or rotate the spindle head about an axis (for instance B-axis) in a defined manner. Also such a movement may be initiated by the operator by impacting on the handle.

Generally, the drives may be arranged as direct drives or as mediately coupled drives. The drives may be coupled to spindles, for instance to ball screw spindles, and to guides, for instance saddle slideways.

According to a further refined embodiment of the machine tool, the at least one detector comprises at least one sensor for detecting deformations of the handle.

The at least one sensor may be arranged as strain gauge strips, for instance, which may be generally utilized for mediate force measurement. However, the sensors may be further generally arranged as piezoelectric, optical, inductive, or capacitive sensors for (mediate) measurement of forces. The at least one sensor may be arranged as a single sensor or as a package of sensors or a sensor array. It goes without saying that single sensors may be combined with each other in an appropriate fashion to obtain more articulated measurement results. By way of example, single sensors may be arranged on sides of the handle that are opposite to each other. This enables to detect compressions and elongations of a compression side and a tensile side, respectively, of the handle. Hence, a more articulated signal may be obtained which describes the deformation of the handle and allows a conclusion as to the impacting force.

According to another embodiment, the at least one detector is arranged to detect deformations of the handle in at least two directions in space.

Consequently, operator impacts may be further evaluated with respect to their direction. It may be achieved in this way to move the spindle head along two axes in a controlled fashion.

To detect deformations in an aerial or spatial fashion, it is suitable to provide a plurality of sensors at the at least one detector. The sensors may be adjusted to each other and arranged at an orientation to each other in an appropriate fashion. For instance, the sensors may be arranged in a crossed, rosetta-shaped or a similar fashion.

Generally, it may be envisaged to detect deformations that are associated with a torsion load at the handle. In this way, the functionality of the machine tool may be enhanced to the effect that also a defined rotation or pivoting of the spindle head about an axis (e.g. B-axis) by motor may be controlled by operator impacts.

According to a further exemplary refinement of the afore-mentioned embodiments, the control device is arranged to generate control commands comprising at least one motion parameter that is dependent on a detected actuating force, particularly dependent on at least a level or direction of the actuating force.

The motion parameters that are reflected in the control commands may involve travel direction, path, speed, acceleration, deceleration and the like. Further, for instance dependent on a threshold value, an ON-signal or an OUT-signal may be generated to selectively permit or prevent the defined motorized movement of the spindle head. To this end, also a so-called confirmation information may be utilized. The confirmation information may be routed to the control device or generated in the control device. As used herein, the term “confirmation” may refer to a deliberate approval of a displacement movement by the operator. For instance, the confirmation information may represent whether an operator actuated an activation switch and/or a confirmation switch or not. In this way, inadvertent displacement movements that are caused by maloperation may be prevented. For instance, the confirmation information may comprise a digital signal that can assume the states “confirmation existing” and “no confirmation existing”.

According to a further development of this embodiment, the control commands comprise a defined travel speed that is dependent on the detected actuating force.

The level of the (mediately) detected actuating force may be evaluated so as to determine the desired travel speed for the spindle head. In other words, by detecting the level and the direction of the actuating force, an actuation vector may be determined. The actuation vector may be reflected in a travel vector for the spindle head which may be characterized by travel direction and travel speed.

It goes without saying that the control device alternatively may be arranged to move the spindle head along an axis or along a plane that is defined by at least two axes at a substantially constant travel speed when the detector detects a mere presence of an operator actuation, regardless of its actual level. In this way, a “digital” control may be enabled. This travel control may be used for instance in the crawler gear to touch reference points at low travel speed. Needless to say, even when the (absolute) level of the operator actuation (e.g. of the actuating force) is not detected, the direction of the operator actuation may be detected and evaluated.

According to yet another embodiment, which may be implemented in the alternative or in addition, the control commands comprise a travel direction which is dependent on a directional component of the detected actuating force.

The detected direction of the actuating force may be utilized to determine a desired direction of the displacement of the spindle head. Accordingly, a “skewed” displacement of the spindle head may be enabled when for instance two axes (e.g. the X-axis and the Z-axis) are controlled in a coordinated fashion and supplied with control commands.

In one exemplary embodiment, the control device is arranged to generate control commands for moving the spindle head that are dependent on at least a further influencing factor, particularly dependent on an actual position of the spindle head.

This may generally involve an ON-signal or an OUT-signal, for instance. It may be ensured in this way that inadvertent impacts on the handle do not cause undesired movements of the spindle head. Further functions may be envisaged. For instance, the at least one further influencing factor may be evaluated so as to determine whether the spindle head is to be moved in a fast gear or a crawler gear.

This measure can be further developed in that the control device is arranged to adapt the travel speed of the spindle head, or to stop the movement of the spindle head, when the spindle head enters a defined region when moving.

A potentially permitted travel region of the spindle head which may be predefined by the design of the guides at the machine bed may be subdivided into regions in which a fast displacement of the spindle head is enabled and further in regions in which a slow movement is enabled, and eventually in regions in which a displacement of the spindle head is unwanted.

A collision monitoring may take place in this way so as to prevent that the spindle head collides with components of the machine tool when moving in a manually controlled fashion. Hence, the operational safety may be further enhanced.

Regions in which no collision risk is present may generally assigned with high travel speed. It may be further envisaged to design approaching regions which may encircle reference points or a particular workpiece geometry. The approaching regions may be further referred to as offset regions. When transferring the spindle head to an approaching region, the control device may act on the displacement drive in such a way that only a crawler gear is enabled. In this way, the operator may move the spindle head at high accuracy, for instance to touch a reference point or the workpiece geometry. In further enabled travel regions, the spindle head may be positioned and displaced at high travel speed. Overall, an excellent trade-off between positioning accuracy and positioning speed may be achieved.

Further, so-called stop regions may be defined in the (theoretically enabled) travel region that may be referred to as shell around machine geometry and which define a (virtual) travel boundary. Unwanted collisions of the spindle head may be prevented in this way when displacing in a manually controlled fashion.

When shifting between regions that enable a fast gear and regions that require a crawler gear, a switch between corresponding “characteristic maps” for linking the detected actuation on the handle and the travel speed may be conducted.

The definition of the respective regions, for instance the subdivision into the enabled travel region, the approaching region and the stop region, may be accomplished in different ways. For instance, raw data of the workpiece geometry and predetermined data of the geometry of the machine tool may be utilized to define the encircling approaching regions and stop regions, at least approximately. The approaching regions and the stop regions may provide an offset to the underlying elements. In this way, a raw detection of predetermined locations and an actual location of the spindle head may provide sufficient accuracy of the raw movement and improved collision safety.

According to another aspect of the machine tool, the handle is arranged as an operating handle and comprises a detection region that is elastically deformable and that particularly comprises a high stiffness, wherein the at least one detector is applied at the detection region.

In other words, the handle may be arranged in an essentially stiff manner and fixedly attached to the spindle head (e.g. to a housing of the spindle head). Virtually subtle elastic deformations may be detected by the at least one detector and evaluated for controlling a displacement event of the spindle head.

Hence, the handle as such may undergo merely particularly tiny deflections. This may have the effect that feedback that is caused by the actual displacement of the spindle head may be sensed and/or detected by the operator nearly unfiltered and directly. No “attenuation” occurs which would be present in considerable deformable handles, for instance. Even when the operator nearly “mediately” acts on the spindle head to displace the spindle head, an all the more clear impression of a “direct” actuation may be present.

The detection region of the handle may be formed from a material comprising a high modulus of elasticity, for instance. Further, the detection region of the handle may comprise a sufficiently large cross section to be sufficiently stiff. Also with considerable stiffness, operator impacts may lead to at least tiniest deformations which may be sensed or detected by the detector.

Depending on the type of the sensors that are implemented at the at least one detector, already a surface elongation in the range of about 100 to about 2,000 μm/m may be sufficient to generate a clear signal. These values may correspond to a relative elongation (Epsilon) of about 8=0.0001 to 0.002. It goes without saying that the mentioned values may be dependent on the choice of the to-be-used sensor and may also basically deviate from the mentioned ranges. The mentioned minimum relative elongations enable to detect the operator actuations at the handle safely and at sufficient accuracy even with elastic deformations that the operator generally cannot notice.

According to exemplary another embodiment, an activation switch is associated with the handle. The activation switch may also be referred to as confirmation switch and may take the form of a confirmation button.

The activation switch may be utilized to selectively enable or prevent the displacement of the spindle head in dependency of the actuations caused by the operator.

By way of example, it may be envisaged to arrange the activation switch such that the activation switch needs to be actuated permanently to enable a manually controlled displacement of the spindle head. Such an exemplary arrangement may contribute to reliably avoid maloperation and damages to the machine tool and the workpiece that are associated therewith. It may be also envisaged to actuate the activation switch once at the beginning of the manually controlled displacement procedure to obtain a release.

The activation switch may be directly attached to the handle, for instance. In this way, a single hand operation may be enabled. However, it may be also envisaged to arrange the activation switch separated from the handle, for instance at the spindle head or at another component of the machine tool in a manner fixed to a frame. In this way, a two-handed operation may be enabled.

According to a further embodiment, the control device is further arranged to generate, dependent on at least one influencing factor, a selective tactile feedback at the handle.

A tactile feedback to the operator may be caused by vibrations that can be sensed at the handle, for instance. The influencing factor may comprise an actual position, an actual speed, an actual actuation force, or a combination thereof. Further influencing factors may be envisaged, for instance the act of exceeding deformed defined travel regions.

According to a refinement of this embodiment, the tactile feedback is generated by at least one vibration transducer that is arranged at the handle, or by means of a kinetic momentum that is generated at the displacement drive of the spindle head.

The vibration transducer may, for instance, be formed by a vibration motor. It may be further envisaged to steer the displacement drive such that a jerking or rattling is present that can be sensed by the operator that engages the handle. To this end, the displacement drive of the spindle head may be steered with an oscillation impulse, for instance.

The tactile feedback may be generated for instance when the spindle head, departing from the enabled displacement region trespasses to the approaching region or touches the stop region. In this way, it may be clearly brought to the mind of the operator that the desired movement (into the stop region) is not allowed. When transferring to the approaching region, the operator may be clearly notified of the fact that the spindle head is from now moved in the crawler gear.

Further events may be envisaged, which may trigger a selective tactile feedback at the handle. For instance, exceeding or undercutting defined value ranges may be signaled in this way. This may for instance relate to the actuating force, the displacement path, the travel speed or the like. A collision monitoring may be for instance performed by a detection of forces or torques in drives that are utilized for the displacement motion. A sudden rise of force or rise of torque at a drive motor may be classified as an indicator of an occurred collision. Also such an event may be notified to the operator by means of a tactile feedback.

According to another embodiment, when moving the spindle head, the drive power of the drives or the travel speed is reduced so as to still enable a displacement, wherein, however, in case of a collision of the grinding head no excessive forces or impacts have to be expected. In this way, a fine trade-off between an (enabled) travel region that is as large as possible, a large displacement flexibility and machine security that is as large as possible may be achieved. This embodiment may be associated with an accurate monitoring of forces, torques or values that correspond thereto, to be able to detect collisions as quick as possible and, accordingly, to quickly stop the involved drives. It is thus not necessarily required with this embodiment to define enabled or forbidden travel regions in advance. The operating and setting effort may be significantly reduced.

In respect of the positioning method, in accordance with another aspect of the present disclosure, the above and further objects of the present disclosure are achieved by a method for positioning a spindle head of a machine tool for machining workpieces, particularly a grinding machine, in at least one operation mode, comprising the following steps:
detecting impacts on a handle, wherein the handle is arranged at a spindle head, and wherein the impacts comprise at least one of a direction information or a force information,
generating control commands for controlling a displacement drive under consideration of motion parameters that are selected dependent on the detected impacts, and
moving the spindle head by means of the displacement drive under consideration of the control commands, wherein the displacement drive is arranged to move the spindle head with respect to a workpiece holder by motor in a defined manner.

The method may be further refined by at least one of the following steps:
monitoring an actual position of the spindle head,
generating a tactile feedback at the handle, and
adapting a travel speed or stopping the movement of the spindle head when the spindle head enters defined regions when moving.

The method may be particularly executed at a machine tool in accordance with the afore-mentioned aspects. It goes without saying that the method may be further refined in accordance with one or more aspects of the afore-mentioned machine tool.

The method enables a manually controlled positioning and displacement of the spindle head of a machine tool in a simple fashion, wherein the operator may move and position the spindle head in an instinctive and intuitive manner, even though merely mediately actuating.

It goes without saying that features of the present disclosure that have been mentioned hereinbefore and will be described hereinafter can be used not only in the respectively specified combination, but also in other combinations or in isolation without departing from the scope of the present disclosure.

### BRIEF DESCRIPTION OF THE DRAWINGS

Further features and exemplary embodiments of the present disclosure are disclosed in the following description of a plurality of exemplary embodiments, with reference to the drawings, wherein:

FIG. 1 shows a perspective view of a machine tool comprising a housing, wherein the machine tool is arranged as a grinding machine;

FIG. 2 shows a top view of a machine tool;

FIG. 3 shows a perspective view of a workpiece holder and a spindle head of a machine tool, wherein the spindle head comprises a handle for actuation;

FIGS. 4a, 4b, and 4c show perspective views of different handles through which impacts on a spindle head may be effected;

FIG. 5 shows a simplified perspective view of another handle comprising a detector having a plurality of sensors;

FIG. 6 shows a simplified side view of a shaft of a handle that is coupled to a detector comprising a plurality of sensors;

FIG. 7 shows a simplified top view of a machine tool having a spindle head that assumes different target positions;

FIG. 8 shows a further simplified perspective representation of a handle that is modified with respect to the representation of FIG. 5; and

FIG. 9 shows a simplified schematic flow chart of an exemplary method for positioning a spindle head of a machine tool.

### DETAILED DESCRIPTION OF EXEMPLARY EMBODIMENTS

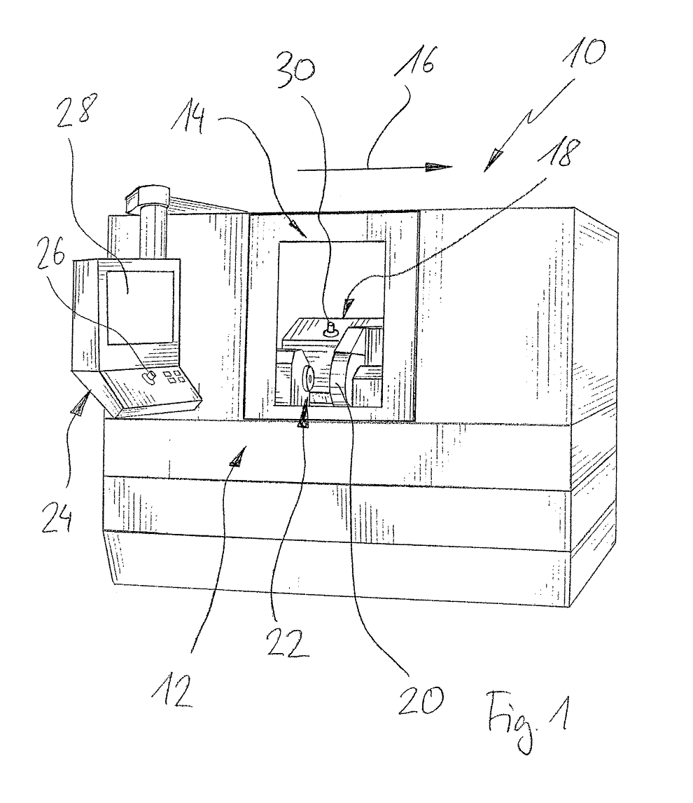

In FIG. 1 a machine tool is shown in a perspective view and denoted by 10.

The machine tool 10 as shown is arranged as a grinding machine, particularly as a cylindrical grinding machine. The machine tool 10 comprises a housing 12 which serves as a casing. The housing 12 comprises an opening which can be closed, for instance, by a protective door 14 at the embodiment shown in FIG. 1. The protective door 14 may comprise a window opening through which an interior space of the machine tool 10 is visible from the exterior. The housing 12 and the projective door 14 enable a safe delimitation of the interior space of the machine tool 10, particularly for automated machining operations. In this way, a general risk emerging from movable components may be minimized. Further, an undesired emission of lubricants, coolants or of cuttings to the environment may be prevented.

In particular operation modes, it is required to open the protective door 14 to make the interior space of the machine tool 10 accessible from the exterior for an operator. To this end, the protective door 14 may be slid and/or pivoted to the side so as to reveal a previously closed opening. An arrow that is designated by 16 elucidates a potential opening motion of the protective door 14.

Operation modes that may require an access to the interior space of the machine tool 10 may involve setting-up procedures, fitting procedures, dressing procedures or, more general, tool change and/or workpiece change operations. It goes without saying that dependent on the degree of automation of the machine tool 10 different operation modes may require a (manual) access from the exterior.

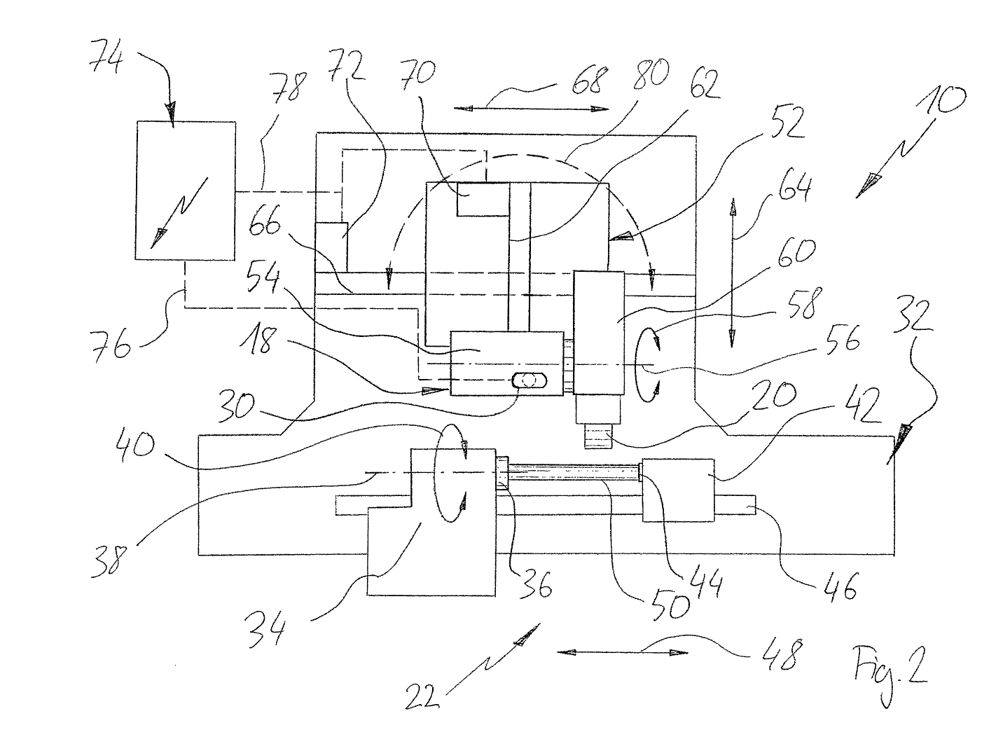

Furthermore, in the interior space of the machine tool 10 a spindle head is indicated in FIG. 1 which is indicated by 18. A tool 20 may be received at the spindle head 18, refer also to FIG. 2 and to FIG. 3. The tool 20 may be arranged, for instance, as a grinding tool, particularly as a grinding wheel.

The machine tool 10 further comprises a workpiece holder 22 which is arranged for receiving a workpiece (not shown in FIG. 1). For machining the workpiece, the spindle head 14 and the tool 20 attached thereto may be moved with respect to the workpiece holder 22.

Machine tools 10, particularly grinding machines, typically comprise an operator interface 24 which is arranged outside of the interior space of the machine tool. In this way, the operator may control, program, steer the machine tool 10, or conduct diagnostic analyses without contacting the interior space of the machine tool 10. The operator interface 24 may be arranged as an operator controller unit that may comprise at least an input unit 26 and at least an output unit 28. The input unit 26 may comprise, for instance, a keyboard, push buttons, control levers and the like. However, the input unit 26 may further comprise touch sensitive surfaces. The output unit 28 may be commonly arranged as a display screen, further as alphanumerical displays, indicator lights, scales, and the like. Particularly when the display screen is arranged in a touch sensitive manner, the input unit 26 and the output unit 28 may be at least partially embodied by the same components.

The operator interface 24 may enable programming the machine tool 10 in a convenient fashion. It may be further envisaged, at an operation mode in which, for instance, the spindle head 18 is to be moved relative to the workpiece holder 22, to manually control the spindle head 18 by inputs at the input unit 26. To this end, adjusting levers or adjusting buttons may be used which define a motion or a motion increment in directions that are assigned thereto. Further, moving or displacing the spindle head 18 may be initiated via hand wheels and the like. As already mentioned at the outset, it is advisable that the operator keeps an eye on the spindle head 18 and the operator interface 24 with this way of manually positioning of the spindle head 18. This may cause uncertainty or even maloperation.

To avoid these drawbacks, the spindle head 18 of the machine tool 10 in accordance with FIG. 1 comprises a handle 30 which is immediately (also, for instance, directly) attached thereto. The handle 30 is movable in conjunction with the spindle head 18.

FIG. 2 illustrates a simplified schematic top view of a machine tool which basically corresponds to or is at least similar to the machine tool 10 according to FIG. 1. For illustrative purposes, the embodiment illustrated in FIG. 2 does not comprise a housing 12 and an operator interface 24.

The machine tool 10 comprises a machine bed (or machine table) 32 (in FIG. 1 covered by the housing 12). At the machine bed 32, the workpiece holder 22 is received. The workpiece holder 22, for instance, comprises a workpiece spindle 34 which is provided with a clamping device (or center) 36. The clamping device 36 may be basically embodied by a (center) point and/or by a chuck, clamping jaws, and the like. The workpiece spindle 34 may further comprise a spindle drive that enables rotating the clamping device 36 in a defined manner about an axis 38, refer also to an arrow indicated by 40.

The workpiece holder 22 further comprises a tailstock 42 which analogous to the workpiece spindle 34, is provided with a clamping device (or center) 44. Between the workpiece spindle 34 and the tailstock 42, a workpiece 50 may be accommodated. This may be arranged as a rod or a shaft. The workpiece 50 may be basically solely guided and received by the workpiece spindle 34 without the need of the tailstock 42. Particularly, with workpieces 50 that comprise a large length-diameter-ratio, it is advisable to receive same at both sides by means of the workpiece spindle 34 and the tailstock 42. Extensively large workpieces 50 may be further guided and supported by rollers and bearings (not shown in FIG. 2). The workpiece spindle 34 and its tailstock 42 may be received and guided at a guide 46 at the machine bed 42. It may be envisaged to provide the workpiece spindle 34 and/or the tailstock 42 with a linear drive to move them along the guide 46 in a defined and controlled manner, refer also to a double arrow indicated by 48.

The drive that may be optionally provided at the workpiece spindle 34 may be arranged and controlled such that the workpiece 50 may be rotated about the axis 38 in a high-precision manner. The axis 38 may be further referred to as C-axis. A so-called C-axis machining may enable to machine non-round workpieces 50. This this end, the machine tool 10 may comprise appropriate control and steer elements to rotate the workpiece 50 in a defined manner about the axis 38 and, at the same time, to infeed the tool 20 to the workpiece 50 and/or to steer the tool 20 from the workpiece 50. In this way, for instance, camshafts, crankshafts and the like may be machined.

Further, a tool table 52 is received at the machine bed 32, which may be also referred to as cross table. The spindle head 18 is received at the tool table 52 which may be arranged as cross table, for instance. By way of example, the spindle head 18 comprises a tool drive 54 which is arranged to rotate the tool 20 about a spindle axis 56, refer to an arrow indicated by 58. Particularly when the tool 20 is arranged as a grinding wheel, also a protective shroud 60 may be received at the spindle head 18 which covers part of the tool 20. In this way, abrasion of the tool 20 and cuttings of the workpieces 50 may be guided and discharged in a defined manner. A contamination tendency of the machine tool 10 may be reduced.

Guides 62, 66 may be formed at the machine bed 32 and/or the tool table 52 at which eventually the spindle head 18 may be received. For instance, the guide 62 may provide a guide in a X-direction. The guide 66 may provide a guide in a Z-direction. A corresponding coordinate system X-Y-Z is shown in FIG. 3, for instance.

In accordance with the embodiment shown in FIG. 2, the tool table 52 may be moved along the guide 66 in the Z-direction, refer also to an arrow indicated by 68. The spindle head 18 may be moved along the guide 62 in the X-direction, refer to an arrow indicated by 64. It goes without saying that the assignment of the axes X-Y-Z to the machine bed 32, the tool table 62 and the spindle head 18 may be effected in a different way and orientation. Further types of coordinate systems may be envisaged, for instance polar coordinate systems or spherical coordinate systems.

The spindle head 18 may be moved along the X-axis (arrow 64) and along the Z-axis (arrow 68), for instance. To this end, the machine tool 10 comprises a displacement drive which may comprise a drive 70 and a drive 72, for instance. The drive 70 may be arranged to move the spindle 18 along the X-axis, for instance. The drive 72 may be arranged to move the tool table 52 and, as a consequence, mediately move the spindle head 18 along the Z-axis, for instance. Generally, the displacement drive may be arranged as a distributed drive having individual drives 70, 72, but also as an integrated drive.

The machine tool 10 further comprises a control device which is denoted by 74 and which is arranged to control displacement motions of the spindle head 18 with respect to the workpiece holder 22, for instance. To this end, the control device 74 may actuate the drives 70, 72 via control lines 78. The required control commands may be generated and executed by a machine control program. In this way, for instance, an automated machining of the workpiece 50 may be effected.

As already indicated above, a handle 30 is arranged at the spindle head 18 which is also coupled to the control device 74. The handle 30 is connected to the control device 74 via a signal line 76. The handle 30 and its particular coupling to the control device 74 enable the operator to move the spindle head 18 along the guides 62, 66 in a defined and controlled manner by manually actuating the handle 30. However, this is not effected by a force that is applied by the operator itself but rather by a defined control of the displacement drive (for instance the drives 70, 72). The operator may impact on the handle 30. Operator impacts, for instance an operator force, may be detected and routed to the control device 74. The control device 74 is arranged to process the detected impacts and to control the displacement drive dependent thereon.

The operator may have the impression to move the spindle head 18 in a self-acting and immediate fashion. This may be achieved by the “translation” of the impacts on the handle 30 into control commands for moving the spindle head 18 in a motorized manner.

It may be envisaged to generate the control commands in such a way that an actuation with high forces may lead to a faster movement of the spindle head 18 than an actuation with low forces. A detection of the direction in which the operator impacts on the handle 30 may be transferred to a control command that comprises a corresponding direction information for the movement of the spindle head 18.

FIG. 2 further shows a dashed double arrow designated by 80. The arrow 80 indicates that the spindle head 18 may be basically also pivoted in a defined manner about an axis that may be perpendicular to a plane that is defined by the X-axis and the Z-axis (arrows 64, 68). Such an axis may be referred to as B-axis. Generally the B-axis may be oriented in parallel to the Y-axis, refer also to FIG. 3. A defined pivoting and/or rotation of the spindle head 18 about this axis may enable a skewed adjustment of the tool 20 with respect to the workpiece 50. It may be also envisaged to swivel-in an additional tool 20 by means of such a motion to engage the workpiece 50 therewith.

Also a movement (rotation, pivoting) about the B-axis may be basically induced by a corresponding impact on the handle 30. To this end, the handle 30 may be skewed and/or twisted.

FIG. 3 shows a perspective view of a portion of, for instance, the machine tool 10 according to FIG. 2, wherein for illustrative purposes the machine bed 32, the tool table 52, the workpiece 50, the control device 74 and further components are not shown. As already indicated above, FIG. 2 shows a (Cartesian) coordinate system designated by X, Y and Z. By way of example, the clamping device 44 that is assigned to the tailstock 42 is arranged as a center.

The spindle head 18 is basically arranged in a manner movable with respect to the workpiece holder 22 (and/or a workpiece 50 that is arranged thereon) in the X-Z-plane. In one operation mode of the machine tool that enables to displace the spindle head 18 in a manually controlled fashion, the operator may appropriately impact on the handle 30 to cause the displacement or positioning of the tool spindle 18. To this end, for instance, the operator may impact on the handle 30 in directions in space comprising directional components that can be basically assigned to the axes X and Z, respectively.

For instance, an impact (tension or compression) in a direction X_{H} may be associated with an operator force F_{X}. An impact of the operator in a direction Z_{H} may be associated with an operator force F_{Z}. By way of example, the handle 30 may be provided with at least one detector or measurement detector (refer also to FIG. 5) that allows to detect a level and a direction of an impact force F. The force F may be decomposed into its components F_{X} and F_{Z}. In this way, a direction information as well as an actuation force information may be obtained, at least in a mediate fashion. Based on this information, the control device may control the displacement drive such that the spindle 18 is movable in the direction that basically corresponds to the direction of the impact. A resulting travel speed may be basically dependent on the level of the actuating force F.

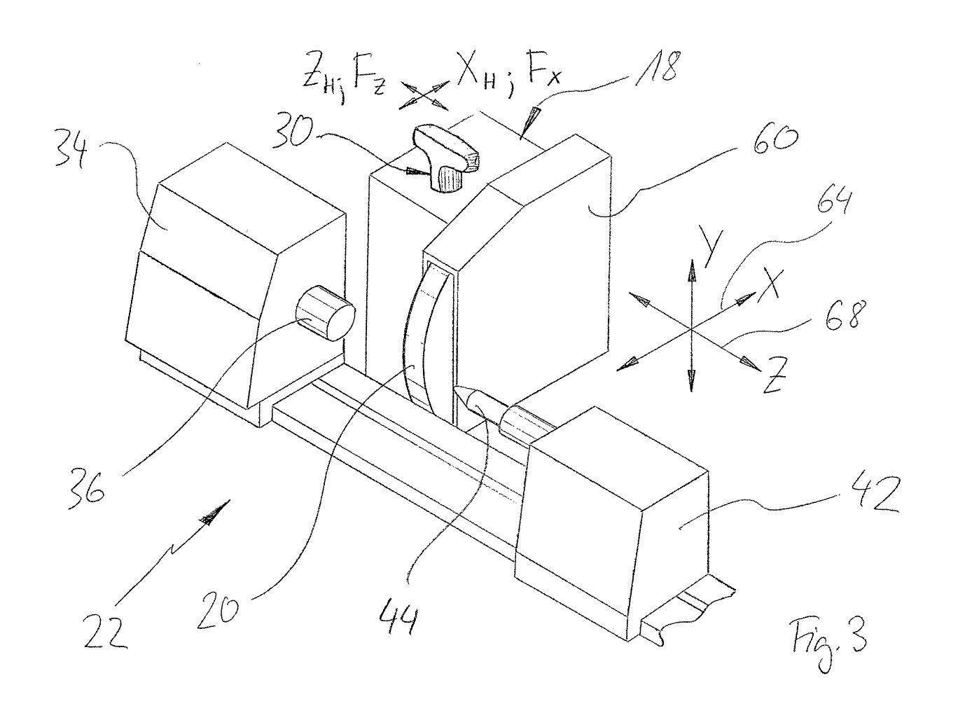

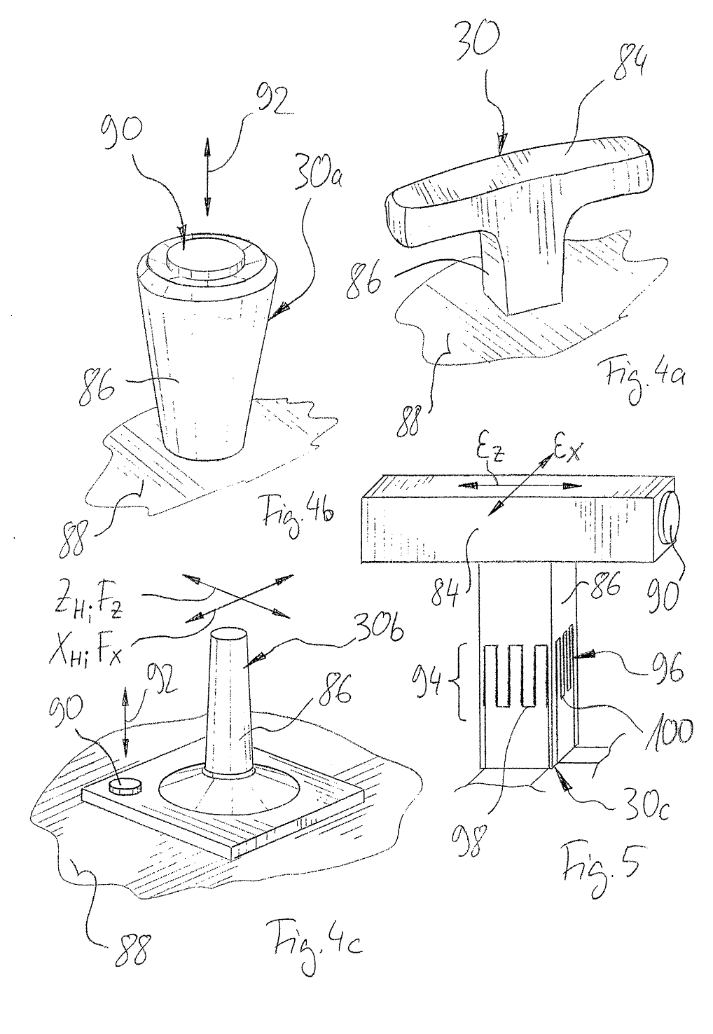

FIGS. 4a, 4b, and 4c show exemplary embodiments of handles 30, 30a, 30b in perspective views. The handle 30 shown in FIG. 4a is arranged as a tee-handle, for instance. A handle 30 comprises a cross piece 84 and a shaft 86. The operator may grab the handle 30 at the cross piece 84 to impact thereon in the desired fashion. The handle 30 may be fixedly attached to the spindle housing 88 (only partially shown in FIG. 4a) via the shaft 86.

The handle 30a of FIG. 4b comprises a knob-shaped or conical shaft 86, for instance, that is particularly fixedly attached to the spindle housing 88. The handle 30a thus not comprise a cross piece 84. At the end thereof that is facing away from the spindle head housing 88, the handle 30a comprises an activation switch 90 which can be actuated by the operator, refer to an arrow that is designated by 92. The activation switch may serve, for instance, to enable or prevent a detection or processing of operator impacts on the handle 30a by the control device 74. It may be prevented in this way that inadvertent impacts on the handle 30a cause inadvertent displacement or positioning of the spindle head 18. With the embodiment shown in FIG. 4b, the operator may grab the handle 30a with one hand and, simultaneously, actuate the activation switch 90 with this hand. Consequently, one-hand operation may be enabled.

As a modification of the handle 30a as shown in FIG. 4b, the handle 30b of FIG. 4c is coupled to an activation switch 90 which is not immediately arranged at the handle 30b and/or at the shaft 86 thereof. It goes without saying that the activation switch 90 may be basically arranged further away from the handle 30b or the spindle head 18 at the machine tool 10. A remotely arranged activation switch 90 allows a two-hands operation.

FIG. 4c further illustrates double arrows X_{H}, Z_{H} which are basically oriented in a fashion parallel to the axes X, Z of the coordinate system X, Y, Z according to FIG. 3. Force components and/or direction components F_{X} and F_{Z} are assigned to the arrows and/or directions X_{H} and Z_{H}. Hence, the operator may impact on the handle 30b in the desired fashion and direction to cause a displacement of the spindle head 18 in the desired direction.

The detection of operator impacts will be elucidated with reference to the illustration of a handle 30c shown in FIG. 5. The handle 30c is for instance arranged in a tee-shaped manner and comprises a cross piece 84 and a shaft 86. The handle 30c may further comprise an activation switch 90 which is laterally arranged at the cross piece 84. The handle 30c further comprises a detection region 94 in which a detector 96 is applied through the shaft 86. By way of example, the detector 96 comprises a plurality of sensors 98, 100. The sensors 98, 100 are arranged at different sides of the shaft 86. By way of example, the sensor 98 is arranged to detect deformations of the detection region 94 of the handle 30c in the X-direction, refer to an arrow designated by ε_{X}. Analogously, the sensor 100 may be arranged to detect deformations of the detection region 94 of the handle 30c in the Z-direction, refer to an arrow designated by ε_{Z}.

In this way, components of the actuating force F_{X}, F_{Z} can be detected in a mediate fashion. It goes without saying that, with the embodiment of the handle 30c shown in FIG. 5, basically a further corresponding sensor may be respectively assigned to the sensor 98 and the sensor 100 at respective opposite sides of the shaft 86 (in FIG. 5 not shown).

As already indicated above, the sensors 98, 100 may be arranged, for instance, as strain gauges, piezo-strictive sensors, capacitive sensors, optical sensors and similar sensors, for instance. The sensors 98, 100 may be arranged to detect an impact, particularly a force, on the handle 30c in a mediate or immediate fashion. The detection region 94 is generally elastically deformable but, however, comprises a high stiffness. Deformations of the detection region 94 that cannot be sensed by the operator itself can be detected by detector 96 comprising the sensors 98, 100 and routed to the control device 74. The control device 74 may generate control commands dependent on direction and dependent on a detected (absolute or relative) value of the impact force F, and transmit the control commands to the displacement drive of the spindle head 18, to move the spindle head 18 in the desired manner.

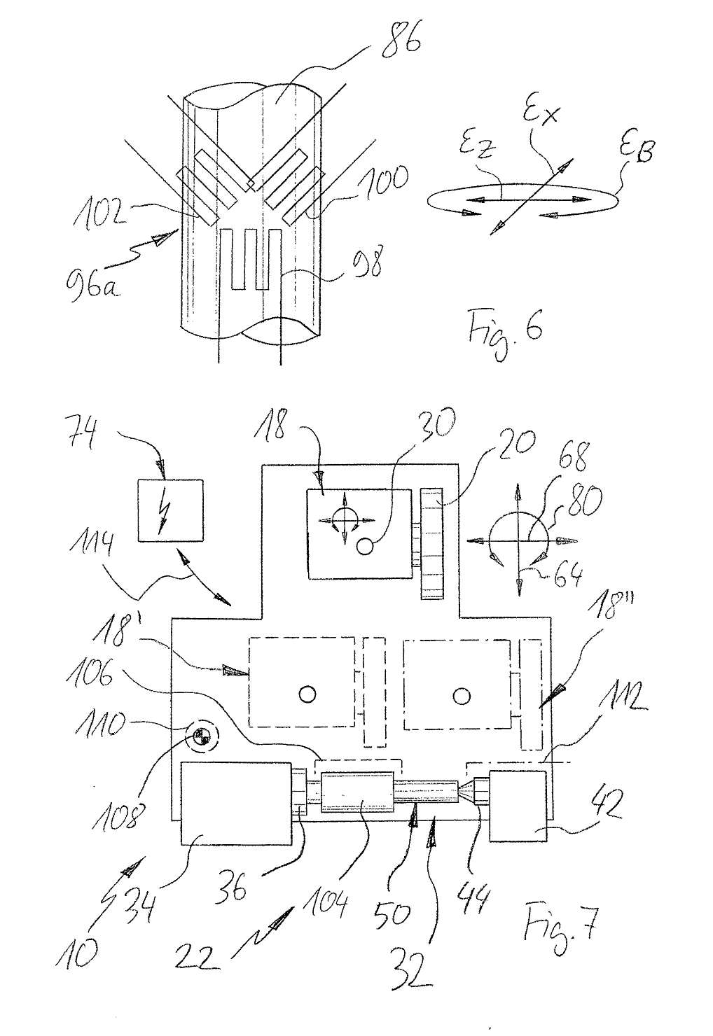

FIG. 6 illustrates in a simplified fashion a broken view of a shaft 86 that may basically correspond to the shaft 86 of the handle 30b according to FIG. 4c. At the shaft 86, a detector 96a is arranged that comprises a plurality of sensors 98, 100, 102. For instance, the sensors 98, 100, 102 are arranged in a rosetta-shaped fashion. Such an arrangement may enable to detect torsional elongations or torsional deformations in addition to the deformations that are basically present along linear axes. By way of example, double arrows designated by ε_{X} and ε_{Z} indicate deformations in the X-direction and the Z-direction, respectively. Further, however, with the rosetta-shaped arrangement of the sensors 98, 100, 102 also a twist and/or torsion of the shaft 86 may be detected, refer to an arrow designated by ε_{B}. In this way, for instance, basically a desired swiveling or rotation of the spindle head 18 about the so-called B-axis may be controlled, refer to the arrow 80 in FIG. 2. It goes without saying that also further assignments between a plurality of sensors of the at least one detector 98a may enable a detection of linear deformations and torsion deformations along and about different axes.

FIG. 7 shows a considerably simplified top view of a machine tool which may be basically arranged in accordance with the machine tool 10 of FIG. 2. This spindle head 18 may be moved via appropriate impacts on the handle 30 in the desired manner along the machine bed 32. For the sake of clarity, the guides 62, 66 and the tool table 52, respectively, are not shown in FIG. 7. Displacing or positioning the spindle head 18 may basically take place in the direction of the arrows 64 and 68, respectively. Further, a pivoting or rotation of the spindle head 18 may be envisaged, refer to the arrow 80.

The machine tool 10 may be arranged in a defined way to facilitate the manually controlled movement of the spindle head 18 and/or to significantly reduce the likelihood of operator errors. To this end, particular regions may be defined at an enabled displacement region which may be limited by fundamental dimensions of the machine bed 32. In these regions, the spindle head 18 may be for instance movable only at reduced travel speed, or moving the spindle head 18 into these regions is totally prevented.

By way of example, the workpiece 50 received at the workpiece holder 22 comprises a grinding portion 104 that has to be approached with the spindle head 18 in a basically defined manner. To this end, an area boundary 106 may be defined which may basically comprise an offset to the grinding portion 104. The control device 74 may be arranged to drive the spindle head 18 at considerably reduced travel speed when the spindle head 18 crosses the area boundary 106. A position of the spindle head 18 is indicated by 18′ in FIG. 7 which is still outside the area boundary 106. When crossing the area boundary 106, the control device 74 may for instance switch from a coarse movement to a fine movement of the spindle head 18. Hence, the operator may approach the grinding portion 104 with the spindle head 18 carefully at high accuracy.

Similarly, the manually controlled touching of reference points with the spindle head 18 may be accomplished. For instance, a reference point 108 is shown in FIG. 7 that is encircled by an area boundary 110. The spindle head 18 may approach the area boundary 110 at relatively high travel speed. When crossing the area boundary 110, the control device may now change into a displacement mode in which the spindle head 18 may be positioned in a high-precision manner at significantly reduced travel speed. In this way, the reference point 108 may be approached in a high-precision fashion, for instance. In a position indicated by 18″, the spindle head 18 is moved close to the tailstock 42. For instance, when the displacement motion continues, a collision with the tailstock 42 may be imminent. To avoid such collisions, again an area boundary 112 may be defined that may basically cover the geometry of the tailstock 42 (or of further components of the machine tool 10) under consideration of an offset. The control device 74 may be arranged to totally prevent a movement of the spindle head 18 across the area boundary 112.

A double arrow indicated by 114 illustrates that the control device 74 may be in communication or functional relationship with a variety of components of the machine tool 10 to implement the manually controlled displacement of the spindle head 18 and the afore-mentioned additional functions.

As already indicated above, the control device 74 may be further arranged to provide a tactile feedback to the operator that engages the handle 30 when crossing or touching one of the region boundaries 106, 110, 112. To this end, the displacement drive of the spindle head 18 may be temporarily operated in an oscillating and/or vibrating fashion to generate a “jolt”. This may be sensed by the operator at the handle 30. Such tactile “feedback” allows the operator to entirely concentrate on the manually controlled displacement of the spindle head without being distracted by optical or acoustic display devices and/or output devices.

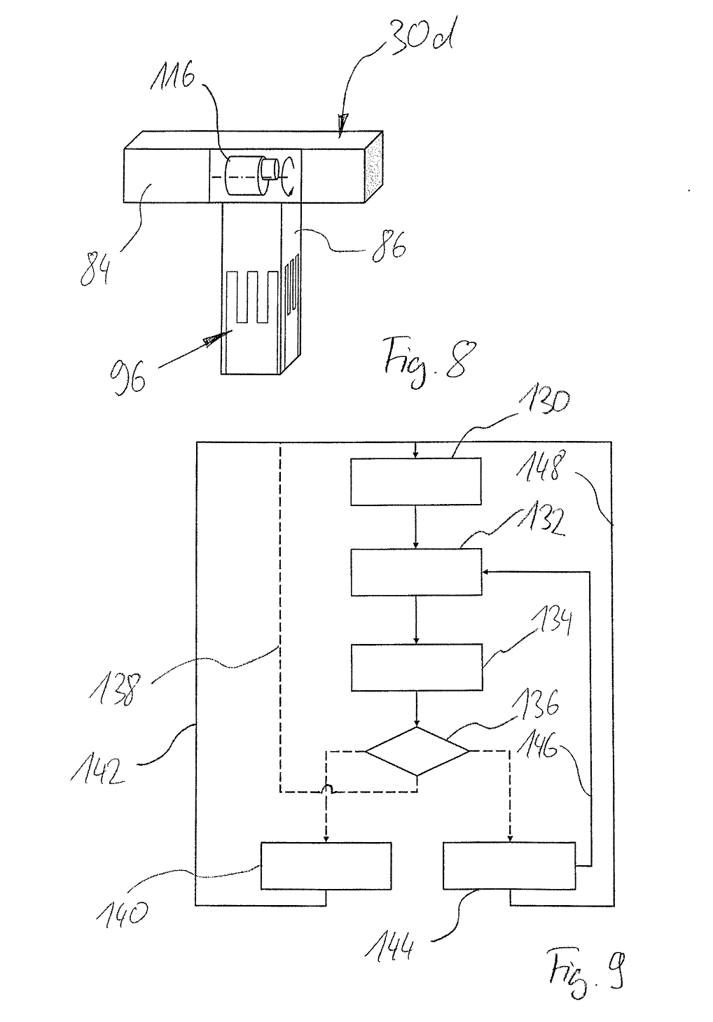

FIG. 8 shows a further exemplary embodiment of a handle 30d that may basically correspond to the handle 30c according to FIG. 5. The handle 30d comprises a vibration transducer 116 that may be arranged as vibration motor, for instance. By means of the vibration transducer 116, directly at the handle 30 a tactile feedback may be generated so as to emphasize the act of approaching or crossing the region boundaries 106, 110, 112 shown in FIG. 7. Generally, a tactile feedback may be triggered by further influencing factors. To these belong, for instance, an excessive actuation force, the achievement of a predefined maximum travel speed and the like.

FIG. 9 illustrates in in a considerably simplified fashion with reference to a schematic flow chart an exemplary method for positioning a spindle head of a machine tool, particularly a grinding machine.

In a step 130, impacts that an operator exerts to a handle that is attached to a spindle head of a machine tool are detected. The impacts may comprise at least one of a direction information or a force information which may be detected and routed for evaluation.

In a further step 132, control commands for controlling a displacement drive are generated which may be performed under consideration of motion parameters that are selected dependent on detected impacts. The motion parameters may involve movement direction, travel speed or travel acceleration, for instance.

In a further step 134, the spindle head is displaced by means of the displacement drive under consideration of the control commands which may be performed relative to a workpiece holder of the machine tool.

The movement of the spindle head may be subject to a permanent monitoring, step 136. The monitoring step may comprise an actual position of the spindle head and a comparison to allowed travel regions for the spindle head. When it is determined in the course of the monitoring step that the spindle head is still positioned within the allowed travel region, the steps of detecting, generating control commands and displacement may be repeated, refer to an arrow 138. The monitoring step (surveillance step) may further relate to influencing factors based on which a selective tactile feedback at the handle may be generated. By way of example, when the monitoring results in that the spindle head touched or even crossed a forbidden region, this may be emphasized to the operator via a tactile feedback, step 140. Again, the steps of detecting, generating and displacement may follow, arrow 142.

In addition, or in the alternative, the monitoring step (surveillance step) may be utilized to detect, based on the detected actual positions of the spindle head and a comparison with allowed and forbidden travel regions, whether the step of generating control commands needs to be varied, step 144. This may involve, for instance, that changed movement parameters are assigned to the detected impacts. For instance, a “characteristic curve” between the detected impacts and the movement parameters that interrelate therewith may be changed. This may even go so far as to cause a stopping or a deceleration of the spindle head when the spindle head enters a forbidden region.

Apart from forbidden regions, also so-called approaching regions may trigger such a variation. In this way, for instance when approaching a reference point, initially a high travel speed for the spindle head and, at a respectively reduced distance, a low travel speed may be selected. The effect on the step of generating control commands is illustrated by an arrow indicated by 146. The steps of detecting, generating control commands and displacing may again follow the step of variation 144, refer to an arrow designated by 148.

What is claimed is:

1. A grinding machine for machining workpieces, the grinding machine comprising:
a workpiece holder for receiving a workpiece,
a spindle head for receiving a grinding wheel,
a handle that is arranged at the spindle head, and
a control device,
wherein the spindle head is movable by motor with respect to the workpiece holder,
wherein the handle comprises at least one detector that is arranged to detect operator impacts on the handle, and
wherein the control device is arranged, in at least one operation mode, to move the spindle head by motor in a defined manner under consideration of the detected operator impacts on the handle.

2. The grinding machine as claimed in claim 1,
wherein the detector is arranged to detect an actuating force that is applied to the handle by the operator.

3. The grinding machine as claimed in claim 1,
wherein the at least one detector comprises at least one sensor for detecting deformations of the handle.

4. The grinding machine as claimed in claim 3,
wherein the at least one detector is arranged to mediately detect an actuating force that is applied to the handle by the operator.

5. The grinding machine as claimed in claim 1,
wherein the at least one detector is arranged to detect deformations of the handle in at least two directions in space.

6. The grinding machine as claimed in claim 1, further comprising:
a displacement drive comprising at least one controlled displacement axis for the spindle head,
wherein the control device routes control commands, that are generated dependent on the detected operator impacts on the handle, to the displacement drive.

7. The grinding machine as claimed in claim 6,
wherein the control device is arranged to generate control commands comprising at least one motion parameter that is dependent on a detected actuating force.

8. The grinding machine as claimed in claim 7,
wherein the control commands comprise a defined travel speed that is dependent on the detected actuating force.

9. The grinding machine as claimed in claim 6,
wherein the control commands comprise a travel direction that is dependent on a directional component of the detected actuating force.

10. The grinding machine as claimed in claim 6,
wherein the control device is further arranged to generate control commands for displacing the spindle head that are dependent on at least a further influencing factor.

11. The grinding machine as claimed in claim 10,
wherein the control device is arranged to generate control commands for displacing the spindle head that are dependent on an actual position of the spindle head.

12. The grinding machine as claimed in claim 11,
wherein the control device is arranged to adapt the travel speed of the spindle head, or to stop the movement of the spindle head, when the spindle head enters a defined region when moving.

13. The grinding machine as claimed in claim 1,
wherein the handle is arranged as an operating handle and comprises a detection region that is elastically deformable, and
wherein the at least one detector is applied at the detection region.

14. The grinding machine as claimed in claim 1, further comprising:
an activation switch that is associated with the handle.

15. The grinding machine as claimed in claim 1,
wherein the control device is further arranged to generate, dependent on at least one influencing factor, a selective tactile feedback at the handle.

16. The grinding machine as claimed in claim 15,
wherein the tactile feedback is generated by at least one vibration transducer that is arranged at the handle.

17. The grinding machine as claimed in claim 15,
wherein the tactile feedback is effected by a kinetic momentum that is induced in the displacement drive of the spindle head.

18. A machine tool for machining workpieces, the machine tool comprising:
a workpiece holder for receiving a workpiece,
a spindle head for receiving a machining tool,
a handle that is arranged at the spindle head, and
a control device,
wherein the spindle head is movable by motor with respect to the workpiece holder,
wherein the handle comprises at least one detector that is arranged to detect impacts on the handle, and
wherein the control device is arranged is arranged, in an equipping mode or a set-up mode, to mediately detect an actuating force that is applied to the handle by the operator and to move the spindle head by motor in a defined manner under consideration of the detected impacts on the handle.

19. A method for positioning, in an equipping mode or a set-up mode, a spindle head of a machine tool for machining workpieces, wherein the spindle head is movable by motor with respect to a workpiece holder of the machine tool, the method comprising the following steps:
detecting operator impacts on a handle, wherein the handle is attached to a spindle head, and wherein the operator impacts comprise at least one of a direction information or a force information,
generating control commands for controlling a displacement drive under consideration of motion parameters that are selected dependent on the detected operator impacts, and
moving the spindle head by means of the displacement drive under consideration of the control commands, wherein the displacement drive is arranged to move the spindle head by motor in a defined manner with respect to the workpiece holder.

20. The method as claimed in claim 19, further comprising the following steps:
monitoring an actual position of the spindle head,
dependent on the detected operator impacts, generating a tactile feedback at the handle, and
adapting a travel speed, or stopping the movement of the spindle head, when the spindle head enters defined regions when moving.
